(19) United States
(12) Patent Application Publication
(10) Pub. No.: US 2012/0242329 A1
(43) Pub. Date: Sep. 27, 2012

(54) DETECTION MODULE OF ROTATION SPINDLE

(76) Inventor: SHOU-YU CHU, Taichung City (TW)

(21) Appl. No.: 13/053,225

(22) Filed: Mar. 22, 2011

(51) Int. Cl. G01B 7/30

(52) U.S. Cl. 324/207.2

(57) ABSTRACT

A rotation spindle detection module includes a magnet retainer that retains at least one precision magnet and is mounted to a rotation spindle; at least one Hall device that detects the precision magnet and is arranged at a fixed position adjacent to the magnet retainer; a circuit board that is coupled to the Hall device and forms a circuit to receive a detection signal from the Hall device. As such, components that are used to detect a rotation spindle, including a Hall device, a precision magnet, and a circuit board, are integrated in a modularized fashion so as to achieve the purposes of easy mounting of the detection module to the rotation spindle.

### TECHNICAL FIELD OF THE INVENTION

The present invention generally relates to detection of a rotation spindle, and more particularly to a detection module that is formed by integration of components, such as a Hall device, a precision magnet, and a circuit board, which are used to detect a rotation spindle in a modularized fashion to thereby ease the mounting of the detection module to the rotation spindle.

### DESCRIPTION OF THE PRIOR ART

Prior art patent references that use Hall detection elements in electrical motor are discussed below:

Taiwan Patent Publication No. 483229 discloses mounting two Hall detection elements in a single-phase direct-current brushless motor to detect the rotational direction of a rotation spindle of the motor. When the motor is subjected to braking, signals received from the two Hall detection elements are used to determine if the rotational direction of the motor is reversed. When reversed rotation occurs, output of a driving device of the motor is cut off to stop the rotation of the motor.

Taiwan Patent Publication No. 513004 discloses using Hall devices to detect variations of magnetic flux of rotor magnets of a brushless motor in operation. Through the detection of the variations of magnetic flux, an output of detection voltage is supplied to a driving circuit of the motor. The driving circuit, based on the detection voltage supplied from the Hall devices, performs an operation control over the DC brushless motor coupled thereto. The operation control includes the detection voltages from two Hall devices, and through selection of high and low potentials, after being processed by a circuit, the driving circuit may obtain a third phase voltage for control the DC brushless motor.

Taiwan Patent No. I251396 discloses a motor that is provided with two Hall detection elements. The two detection elements are not allowed to simultaneously detect an interface between a north pole and a south pole of a rotor. Thus, when the motor is activated and one of the detection elements detects the interface between the north pole and the south pole of the rotor and causes jitter, identification can be made through the signal detected by the other detection element being kept at a given level, whereby power supply to the motor can be cut off to protect the motor against being damaged.

Taiwan Patent No. I273391 discloses a servo motor comprising an angle detection and monitoring device. The angle detection and monitoring device comprises a magnetic element mounted to a rotor and two Hall devices mounted to a stator to detect the variation of magnetic field generated by the magnetic element. A control device receives signal fed back from the Hall devices and operates according to a computation process of rotating factor to process the feedback signal and then determines an output of driving signal to the rotor based on comparison made between the processed feedback signal and an external control signal.

Taiwan Patent No. I302401 discloses a detection module composed of Hall devices that detects the position of magnetic pole of a motor in order to generate a detection signal; a shifting module that generates a phase shifting value; a correction module that receives the detection signal and the phase shifting value and generates a phase correction signal based on the detection signal and the phase shifting value; and a driving module that receives the phase correction signal and generates a driving current according to the phase correction signal for driving the motor.

Taiwan Utility Model No. M294775 discloses a motor over-current protection device, which comprises a detection unit, a driving unit, and a control unit. The detection unit comprises a magnet attached to a circumferential surface of a rotation spindle and a Hall device arranged at one side of the rotation spindle and corresponding to the magnet. The driving unit is electrically connected between a control port and the control unit. When the motor is put into operation, each time when the magnet opposes the Hall device, the Hall device supplies an output of a pulse signal. If increment of the pulse signals in a unit of time does not reach a predetermined rotational speed threshold set by the controller, then the control unit controls the driving unit to stop the operation of the motor in order to protect the motor from damage by increases of electrical current.

An example of application of Hall sensor to an electro-mechanical device is illustrated in Taiwan Utility Model No. M363738. The Utility Model provides an electro-mechanical device using Hall sensor, comprising a stator, a rotor that is fit outside the stator, and at least one Hall sensor. The rotor comprises multiple permanent magnetic poles. The stator comprises a plurality of coil winding teeth that extends outward from an axis to receive coils wound thereon. A winding-free spacing tooth is arranged between two adjacent winding teeth. At least one spacing tooth comprises a frame extending axially and the frame is coupled to a circuit board. The circuit board comprises at least one Hall sensor mounted thereon to detect the positions of the permanent magnetic poles of the rotor.

Besides motors using Hall devices to detect angular positions of rotors, an optic encoder (rotary) is also widely used in motor rotor detection, rotation spindle of power device, or spindle of machine tool for detection of speed or angle (position). The optic encoder is advantageous in easy miniaturization and extended detection distance. However, since the rotary encoder is a precise device, it is not fit to a rotation spindle that is subjected to severe vibration.

### SUMMARY OF THE INVENTION

The prior art references mentioned above all disclose magnetic element(s) mounted to a circumferential surface of a motor rotation spindle, Hall device(s) that detect variation of magnetic field or magnetic pole of the magnetic element, and a control device that receive an output signal from the Hall device. Although these prior art references do not explicitly disclose the way and the structure of mounting the magnetic element, the Hall device, and the control device, it is commonly known to those skilled in the art that all the components and a circuit board of the control device are separated and individual parts, and mounting and removing these parts requires first removal the casing of motor and some other internal components. This makes the mounting extremely complicated and difficult.

In view of these problems, the present invention aims to provide a solution for mounting a detection device for a rotation spindle. The solution comprises integration of components for detection of rotation spindle, such as a Hall device, a precision magnet, and a circuit, in a modularized form in order to simplify the operation of mounting the detection device to a rotation spindle.

Further, magnets and Hall devices that are commonly used in an existing permanent-magnet brushless motor to detect the rotational position of a rotor may also be combinable with the modularized structure of the present invention, whereby mounting the components for detecting rotor position is made easy

Besides the application to a rotor of motor, the modularized structure according to the present invention is also applicable to a rotation spindle of an electro-mechanical device, an output spindle of a power device, and a spindle of a machine tool for detection of the speed or angle (position) of the spindle.

The precision magnet according to the present invention is mounted through a magnet retainer to a rotation spindle.

The Hall device is arranged at a fixed position adjacent to the magnet retainer. Preferably, the fixed position is mounted on a Hall device retainer, or a circuit board that forms a circuit that receives a detection signal of the Hall device.

A rotor rotation detection magnet that is used to detect the rotational position of a rotor of a permanent-magnet brushless motor can be mounted on the magnet retainer, while a Hall device that is used to detect the rotor rotation detection magnet is arranged at a fixed position adjacent to the magnet retainer.

A zero position magnet that is used to determine a zero position of a rotation spindle can be mounted to the magnet retainer, while a Hall device that is used to detect the zero position magnet is arranged at a fixed position adjacent to the magnet retainer.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a cross-sectional view showing a rotation spindle detection module according to a first embodiment of the present invention mounted to a motor.

FIG. 2 is a right hand side elevational view of FIG. 1.

FIG. 3 is a front view of a magnet retainer according to the first embodiment of the present invention.

FIG. 4 is a cross-sectional view of the magnet retainer according to the first embodiment of the present invention.

FIG. 5 is a front view of a Hall device retainer according to the present invention.

FIG. 6 is a cross-sectional view of the Hall device retainer according to the present invention.

FIG. 7 is a front view of a magnet retainer according to a second embodiment of the present invention.

FIG. 8 is a cross-sectional view of the magnet retainer according to the second embodiment of the present invention.

FIG. 9 is a cross-sectional view showing a rotation spindle detection module according to a second embodiment of the present invention mounted to a motor.

FIG. 10 is a right hand side elevational view of FIG. 9.

FIG. 11 is a schematic view illustrating directions of magnetic poles of a precision magnet according to the present invention.

FIG. 12 is a schematic view illustrating directions of magnetic poles of the precision magnet according to the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

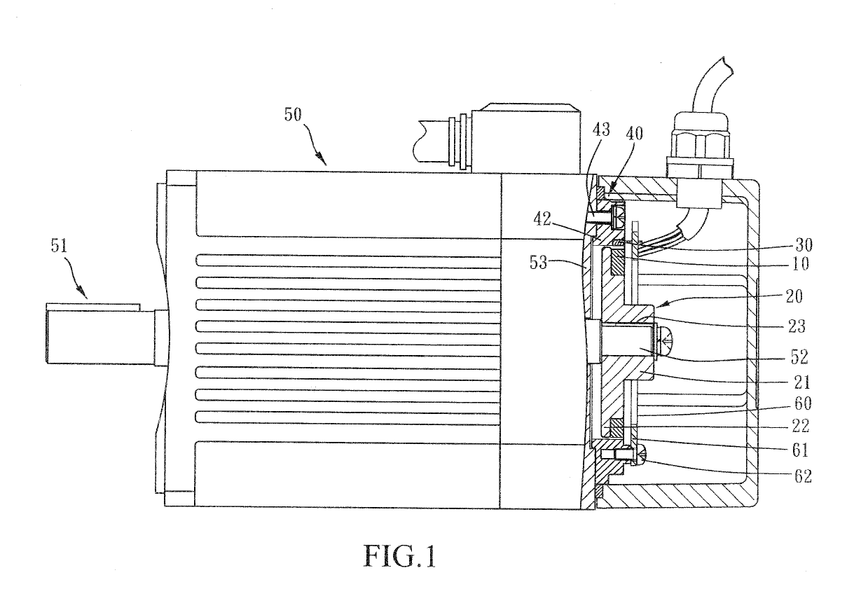

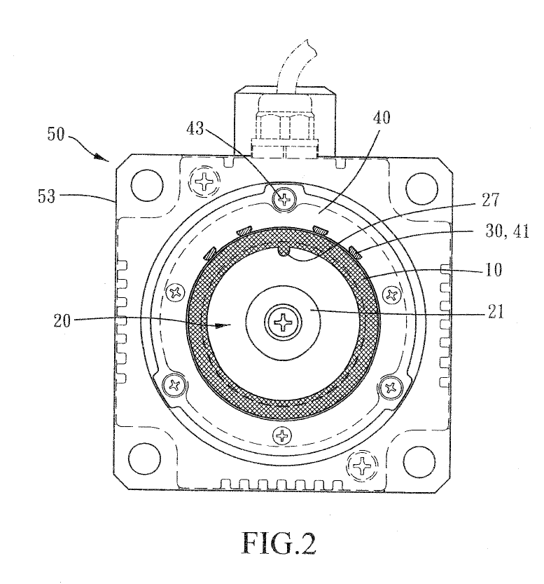

FIGS. 1 and 2 show a rotation spindle detection module according to a first embodiment of the present invention. This embodiment will be explained with reference to an electrical motor, but is not limited thereto. Besides an electrical motor, the present invention is also applicable to a rotation spindle of an electromechanical device, an output spindle of a power device, or a spindle of a machine tool. The rotation spindle detection module comprises a magnet retainer 20 that is provided for retaining and fixing a precision magnet 10, Hall devices 30 that are provided to detect magnetic poles of the precision magnet 10, and a circuit board 60 that is coupled to each of the Hall devices 30.

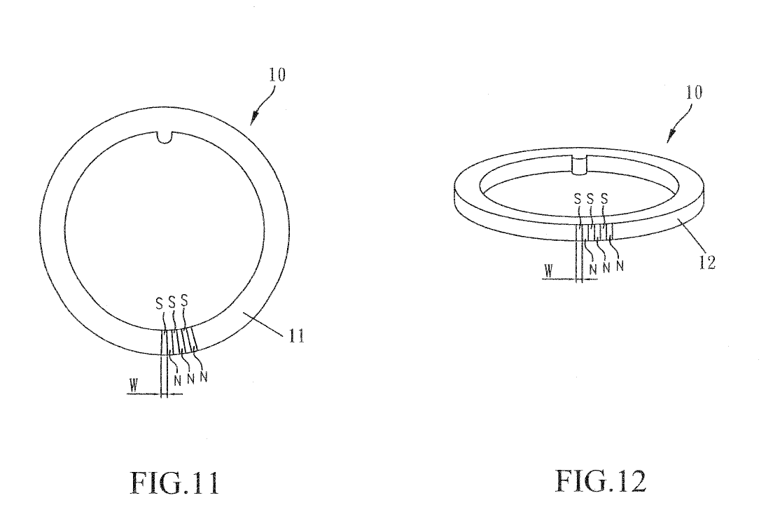

The magnet retainer 20 is mounted to an end 52 of a rotation spindle 51 of a motor 50. As shown in FIGS. 11 and 12, the precision magnet 10 is of a ring-shaped structure in the embodiment illustrated, having multiple north (N) and south (S) magnetic poles. The magnetic pole directions of the north and south magnetic poles can be set by being magnetized on an axial end surface 11 of an axial direction of the ring-shaped structure (see FIG. 11), or alternatively being magnetized on a circumferential surface 12 of the ring-shaped structure (see FIG. 12). In the instant embodiment, each of the north and south magnetic poles is defined with a magnetic pole width W, which is less than 3 mm.

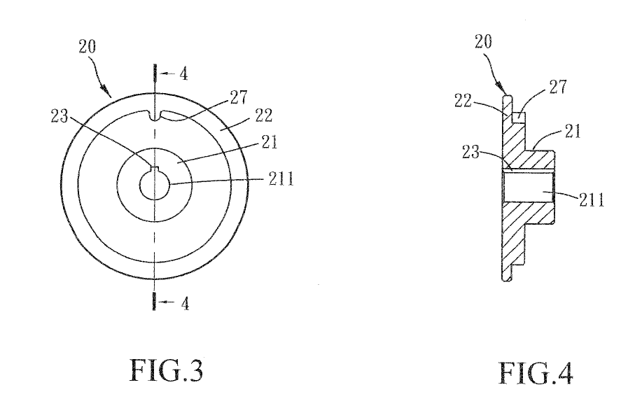

An example of detailed structure of the magnet retainer 20 is shown in FIGS. 3 and 4. In the instant embodiment, the magnet retainer 20 comprises a central hub 21 and a magnet retention section 22. The central hub 21 forms a mounting bore 211 extending through a center thereof. The magnet retainer 20 is fit to the end 52 of the rotation spindle 51 of the motor 50 with the mounting bore 211 in such a way that the end 52 and the central hub 21 are rotatably fixed. A rotation fixing structure 23 that realizes the rotatable fixation is provided at coupling portions between the end 52 and the central hub 21 and may include a key and a keyway that mate each other. In the embodiment illustrated, the end 52 of the rotation spindle 51 of the motor 50 projects outside a motor casing 53, so that mounting the magnet retainer 20 is an operation that is irrelevant to the motor casing, assembling/disassembling of the motor body and internal components thereof, making the mounting operation easy and simple. However, the present invention is not limited to such an arrangement, and as an alternative, the magnet retainer 20 can be mounted inside the motor.

The precision magnet 10 is attached to the magnet retention section 22 in such a way that the magnet retention section 22 and the precision magnet 10 are rotatably fixed to each other. A rotation fixing structure 27 that realizes the rotatable fixation is provided at coupling portions between the magnet retention section 22 and the precision magnet 10, including but not limited to mated recess and projection.

The Hall devices 30 are arranged at a fixed position adjacent to the magnet retainer 20. In the embodiment illustrated, the fixed position is realized through a Hall device retainer 40. The Hall device retainer 40 is mounted to an end of the casing 53 of the motor 50.

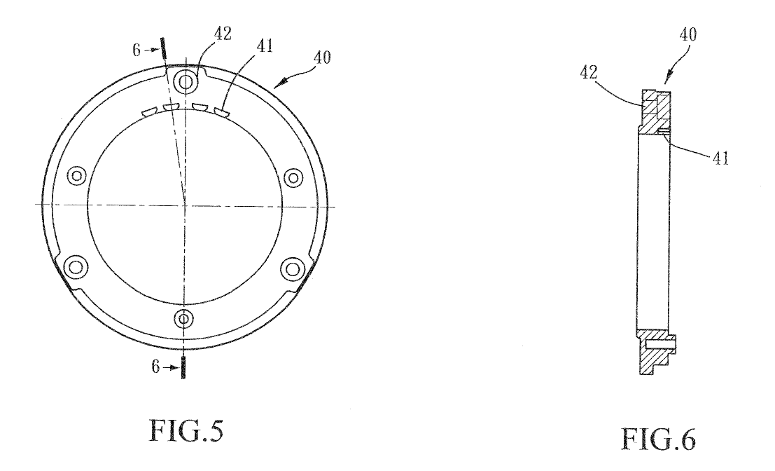

An example of a detailed structure of the Hall device retainer 40 is shown in FIGS. 5 and 6. In the instant embodiment, the Hall device retainer 40 forms predetermined Hall device compartments 41 according to the number of Hall devices used. Each Hall device compartment 41 receives and retains therein one Hall device 30. The Hall device retainer 40 comprises a mounting section 42. In the embodiment illustrated, the mounting section 42 forms a screw receiving hole that receives a screw 43 to secure the Hall device retainer 40 to the end of the casing 53 of the motor 50. The Hall devices 30 are located at positions to detect the magnetic poles of the precision magnet 10. The Hall devices 30 detect the variations of the magnetic poles and generate signals to the circuit board 60. The retained position and retained fashion of the Hall device retainer 40 include, but not limited to, what illustrated, in the drawings.

The circuit board 60 comprises a circuit for receiving the detection signals from the Hall devices 30. The circuit board 60 is arranged at a fixed position adjacent to the Hall devices 30. An example of a detailed structure of the circuit board 60 is shown in FIG. 1. The circuit board 60 comprises at least one mounting section 61, and in the embodiment illustrated, the mounting section 61 forms a screw receiving hole that receives a screw 62 to secure the circuit board 60 to the Hall device retainer 40. The retained position and retained fashion of the circuit board 60 include, but not limited to, what illustrated in the drawings. Alternatively, the circuit board 60 can be mounted to the casing 53 of the motor 50.

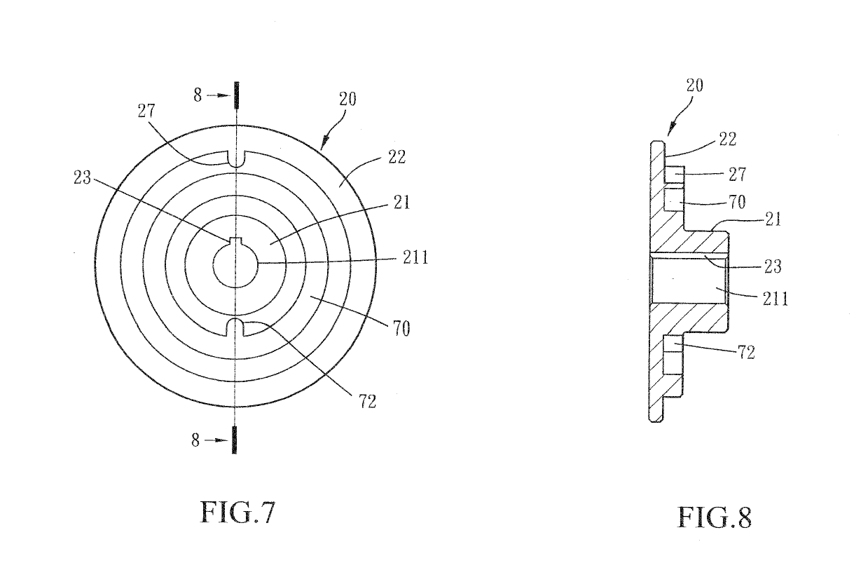

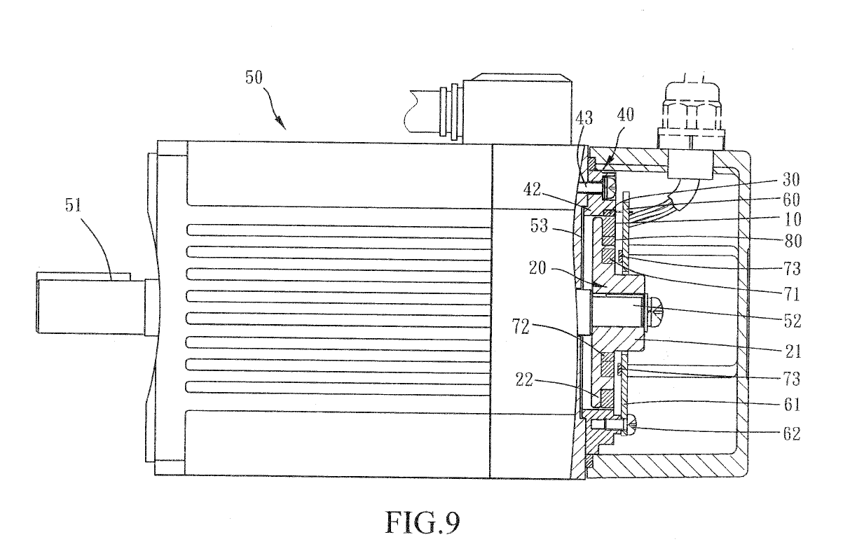

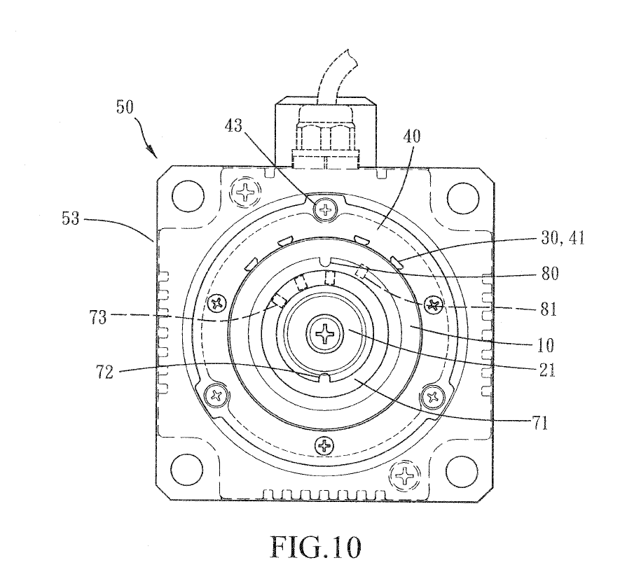

FIGS. 7-10 illustrate a second embodiment of the magnet retainer 20 according to the present invention, which additionally combines a rotor magnet retention section 70 to the structure of the first embodiment. A rotor rotation detection magnet 71 that has a specific number of poles (such as 2P, 4P, 8P and so on) corresponding to the poles of the motor is mounted to the rotor magnet retention section 70. The rotor magnet retention section 70 and the rotor rotation detection magnet 71 are rotatably fixed to each other. A rotation fixing structure 72 that realizes the rotatable fixation is set at coupling portions between the rotor rotation detection magnet 71 and the rotor magnet retention section 70 and includes, but not limited to, mated recess and projection. Hall devices 73 that provided for detecting the rotor rotation detection magnet 71 are arranged at a fixed position adjacent to the magnet retainer 20. The fixed position includes, but not limited thereto, a position mounted on the circuit board 60. The circuit board 60 forms a circuit for receiving detection signals from the Hall devices 73. The Hall devices 73 detect the directions of magnetic poles of the rotor rotation detection magnet 71 and generate signals corresponding to the magnetic pole directions to the circuit board 60.

A zero position magnet 80 for determination of a zero position of the rotation spindle is realized by magnetization of the rotation fixing structure 27 of the precision magnet 10. In the embodiment illustrated, this is a preferred way, but the present invention is not limited thereto. A Hall device 81 for detecting the zero position magnet 80 is arranged at a fixed position adjacent to the magnet retainer 20. The fixed position includes, but not limited thereto, a position mounted on the circuit board 60. The circuit board 60 forms a circuit for receiving a detection signal from the Hall devices 81.

In summary, the embodiments shown above provide potential ways of modularized integration of Hall devices, magnets, and a circuit board that are needed for detection of rotation spindle. The modularized arrangement is preferably mounted to an end of the rotation spindle of a motor for the advantages of easy mounting. As such, the purposes of controlling the motor through magnetism induced signals can be easily realized.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A rotation spindle detection module, comprising:
a magnet retainer, which is adapted to mount to a rotation spindle;
a precision magnet, which is mounted to the magnet retainer, the precision magnet having multiple north and south magnetic poles, each of which has a width less than 3 mm;
at least one Hall device, which detects the precision magnet and is arranged at a fixed position adjacent to the magnet retainer; and
a circuit board, which is coupled to the Hall device, the circuit board forming a circuit that receives a detection signal from the Hall device.

2. The rotation spindle detection module according to claim 1, wherein the magnet retainer comprises a central hub and a magnet retention section, the central hub being mounted to the rotation spindle, the magnet retention section receiving and retaining the precision magnet thereon.

3. The rotation spindle detection module according to claim 1, wherein the fixed position of the Hall device is mounted to a Hall device retainer and the circuit board is arranged at a fixed position adjacent to the Hall device.

4. The rotation spindle detection module according to claim 3, wherein the Hall device retainer forms Hall device compartments according to number of Hall devices used, each of the Hall device compartments receiving and retaining a Hall device.

5. The rotation spindle detection module according to claim 1, wherein the fixed position of the Hall device is mounted to the circuit board.

6. The rotation spindle detection module according to claim 1 further comprising a zero position magnet for determination of a zero position of the rotation spindle, the zero position magnet being mounted to the magnet retainer, a Hall device being provided to detect the zero position magnet and arranged at a fixed position adjacent to the magnet retainer, the circuit board forming a circuit that receives a signal from the Hall device that detects the zero position magnet.

7. The rotation spindle detection module according to claim 1, wherein the precision magnet further comprises a zero position magnet that determines a zero position of the rotation spindle, a Hall device being provided to detect the zero position magnet and arranged at a fixed position adjacent to the magnet retainer, the circuit board forming a circuit that receives a signal from the Hall device that detects the zero position magnet.

8. The rotation spindle detection module according to claim 1, wherein the magnet retainer comprises a rotor magnet retention section, a rotor rotation detection magnet having a number of magnetic poles corresponding to poles of the motor and being mounted to the rotor magnet retention section, a Hall device for detecting the rotor rotation detection magnet being arranged at a fixed position adjacent to the magnet retainer, the circuit board forming a circuit that receives a signal from the Hall device that detects the rotor rotation detection magnet.

9. The rotation spindle detection module according to claim 1, wherein the precision magnet has a ring-shaped structure, the north and south magnetic poles being formed by magnetization on an axial end surface in an axial direction of the ring-shaped structure.

10. The rotation spindle detection module according to claim 1, wherein the precision magnet has a ring-shaped structure, the north and south magnetic poles being formed by magnetization on a circumferential surface of the ring-shaped structure.
